(19) United States
(12) Patent Application Publication
(10) Pub. No.: US 2023/0080674 A1
(43) Pub. Date: Mar. 16, 2023

(54) Systems and Methods for Automated Generation of Passage-Based Items for Use in Testing or Evaluation

(71) Applicant: Duolingo, Inc., Pittsburgh, PA (US)

(72) Inventors: Yigal Attali, Pittsburgh, PA (US); Andrew Runge, Pittsburgh, PA (US); Kevin Yancey, Pittsburgh, PA (US); Geoffrey T. LaFlair, Pittsburgh, PA (US)

(21) Appl. No.: 17/942,626

(22) Filed: Sep. 12, 2022

Related U.S. Application Data
(60) Provisional application No. 63/243,857, filed on Sep. 14, 2021.

(51) Int. Cl. G09B 7/06; G06F 40/279

(52) U.S. Cl. CPC G09B 7/06; G06F 40/279

(57) ABSTRACT

Systems, apparatuses, and methods for automatically generating text items that may be used on an exam or test. In some embodiments, the text items may take the form of a question or statement. The exam or test may be used for evaluating a test-taker's knowledge, proficiency, reading comprehension, or other similar purpose or goal.

### CROSS REFERENCE TO RELATED APPLICATION

This application claims the benefit of U.S. Provisional Application No. 63/243,857, filed Sep. 14, 2021, and titled “Systems and Methods for Automated Generation of Passage-Based Items for Use in Testing or Evaluation”, the disclosure of which is incorporated in its entirety by this reference.

### BACKGROUND

The advent of internet-based computerized skills assessment offers many advantages compared to more traditional paper-based assessments. These include support for innovative item types and alternative item formats, measurement of more complex knowledge, skills, and competencies, automated scoring which also allows immediate feedback to students, and adaptive testing and testing on-demand. These advantages have resulted in increased summative as well as formative testing and, consequently, the challenge of needing higher levels of test item development to support these new features of testing.

One method that may be used to address this challenge is through automatic item generation. Automatic item generation (AIG) is typically based on the notion of item “models” (Bejar 2002), that is schemas of problems with parameters that can be instantiated with specific values. For example, the model X+Y=?, where X and Y can be any whole numbers in the range 0-9, has two parameters. An item model can be instantiated, using a computer-based algorithm, to display an actual test or evaluation item (in this case, a single-digit addition exercise).

Automatic Item Generation (AIG) has been used to create items in diverse content areas and formats. From a practical standpoint, the use of item models expands the potential number of items that may be generated. From a theoretical standpoint, item models provide an opportunity for a construct-driven approach to item development because the generated items can be mapped to the construct through an analysis of the cognitive mechanisms related to the item solution and item features that call on these mechanisms.

However, an important limitation of the item model approach and its conventional implementation is that it is limited in scope to content areas that are sufficiently easy to model (such as mathematics). In addition, because the item generation process depends on highly skilled content experts to create the models, the AIG process is semi-automated and can be costly to implement in terms of the required resources.

As a result, use of AIG as a technique to populate test or examination content is limited to simple tasks. An example of a complex type of task that is not amenable to AIG is a reading comprehension task, which is the most common method used for assessment of higher-level verbal skills and abilities. For example, Sphinx, which is typically considered the most advanced system for the automated generation of reading comprehension assessments, is a hybrid system that automatically generates reading texts. However, the system relies on human experts to generate reading comprehension questions, and item models to generate simple grammatical questions, such as sentence fragment correction questions.

Embodiments of the disclosure overcome these and other disadvantages of conventional approaches to generating content for evaluating the performance of a test-taker, both collectively and individually.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

This disclosure is directed to systems, apparatuses, and methods for automatically generating text items that may be used on an exam or test. In some embodiments, the text items may take the form of a question or statement. The exam or test may be used for evaluating a test-taker's knowledge, proficiency, understanding, comprehension, or other similar purpose or goal.

In one embodiment, the disclosure is directed to a method (and associated system, platform, or apparatus) for using a Transformer-based Language Model (for example, Generative Pretrained Transformer 3 or GPT-3) to automatically generate a set of content-controlled passages, and test items for each passage that can be used to evaluate a test taker's comprehension of the text. These test questions or items may be used to probe a test taker's comprehension of the text and their ability to synthesize and distill the information beyond simple vocabulary or standard questions (what, where, who, or why, as examples) that are generated using templates or conventional automated methods. Further, the test items are generated in a way that enables them to be automatically scored, thereby reducing, or eliminating the need for human resources as part of the test generation and scoring processes.

In one embodiment, the disclosure is directed to a method for automatically generating and selecting a set of test or examination items. In one embodiment, the general form of the data processing flow and associated logic implemented as part of the method may comprise:
Generate a set of text “Source Passages” using a Transformer-based Language Model by providing:
   A set of Instructions (i.e., goals or general characteristics of the desired output) for the model;
      Non-limiting examples of goals or characteristics include
         Format of a generated passage;
         Length of a generated passage;
         Style or comprehension level of a generated passage;
   A set of “Examples” for use in “seeding” the transformer-based model;
      Each example is text and may be associated with one or more of a desired format, subject matter, or style;
      Each example may be associated with a set of attributes and values (of the attribute) used to further describe the characteristics which the example represents;
   A relevant “Conditioning”, i.e., a set of attributes used to control the final characteristics of the generated text;
      Examples of a “condition” include but are not limited to or required to include topic, sub-topic, names of characters, argumentative position (e.g., supports, opposes), length (e.g., number of paragraphs or sentences), a set of keywords to incorporate into the text, or a narrative perspective (e.g., 1st or 3rd person);
Filter the generated Source Passages to identify/select those that are best suited for generating test items;
   This filtering may be based on a rule-set, one or more criteria related to content, subject matter, or another relevant attribute, as examples;
Generate one or more alternative passages for the selected source passage using one or more of the attributes and associated values of the selected source passage as the conditioning for the transformer-based language model;
   This leads to the generation of a set of topically and stylistically similar related “Alternative Passages” with distinct content for each selected Source Passage;
   This may be done using the process for generating Source Passages and the same Conditioning attributes as those used to generate the selected Source Passage (or a subset of those attributes);
   In one embodiment of this process, the Source passage is used as the example for the language model;
   In some embodiments, generating alternative passages relies on the non-deterministic nature of the language model to generate passages different from the source passage, even given the same inputs;
Based on the selected Source Passage(s), for each such passage, generate a set of possible correct responses to one or more multiple-choice questions using a Transformer-Based Language Model (or Models) by providing:
   A set of Instructions for the model;
   A set of Examples to demonstrate the task;
      Where each example consists of a text passage and a set of one or more possible correct answers to a multiple-choice question based on the passage;
   The selected Source Passage for which correct answers will be generated;
      for generating the possible correct answers to the question, the source passage itself is used as the conditioning;
Using the set of Alternative Passages generated or corresponding to each selected Source Passage, generate a set of possible incorrect responses to each of the multiple-choice questions referred to in the previous step using a Transformer-based Language Model by providing:
   The same Instructions and Examples used to generate the possible correct response(s) for the selected Source Passage;
   The Alternative Passage for which answers will be generated as the Conditioning;
Filter the generated test items (the possible correct and/or incorrect responses) to remove categories of subject matter that are not appropriate or do not satisfy one or more desired metrics;
   For possible correct responses, non-limiting examples of such metrics include:
      similarity to the source text as estimated by vector similarities of the text encoded by a separate language model;
      similarity to individual sentences within the source text via the above mechanism;
      N-gram overlap with the source text;
      probability of the generated answer under the transformer-based language model;
      probability of being correct as estimated by a separately trained question answering model;
      length; or
      presence of overly rare words;
   For possible incorrect responses, non-limiting examples of such metrics include:
      similarity to the source text;
      similarity to the chosen correct answer;
      similarity to unchosen potential correct answers;
      similarity to other incorrect answers;
      difference in probability of the generated text as measured by the output distribution over tokens of the transformer-based language model between the incorrect answer and the correct answer;
      length relative to the chosen correct answer; or
      presence of overly rare words; and
Construct a set of test items using the selected correct response (or responses) generated for each selected Source Passage as the correct answer(s) and the selected incorrect responses generated for the Corresponding Alternative Passage(s) as the incorrect answer(s) for each of the multiple-choice questions for which answers were generated.

In one embodiment, the disclosure is directed to a system for automatically generating and selecting a set of test or examination items. The system may include a set of computer-executable instructions stored in a memory or other data storage element (such as a non-transitory computer-readable medium) and one or more processors or co-processors. When executed by the processors or co-processors, the instructions cause the processors or co-processors (or a device or devices of which they are part) to perform a set of operations that implement an embodiment of the disclosed method or methods.

In one embodiment, the disclosure is directed to a non-transitory computer-readable medium containing a set of computer-executable instructions, wherein when the set of instructions are executed by one or more electronic processors or co-processors, the processors or co-processors (or a device or devices of which they are part) perform a set of operations that implement an embodiment of the disclosed method or methods.

In some embodiments, the systems and methods disclosed herein may provide services through a SaaS or multi-tenant platform. The platform provides access to multiple entities, each with a separate account and associated data storage. Each account may correspond to a user, a set of users, an entity, a set or category of entities, a set or category of users, a set or category of data, an industry, or an organization, for example. Each account may access one or more services, a set of which are instantiated in their account, and which implement one or more of the methods or functions disclosed herein.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical elements. While the embodiments disclosed or described herein are susceptible to various modifications and alternative forms, specific embodiments are shown by way of example in the drawings and are described in detail herein. However, the exemplary or specific embodiments are not limited to the forms described or intended to limit the set of possible embodiments. Rather, the present disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1 is a flowchart or flow diagram illustrating a method, process, operation, or set of functions that may be used in implementing an embodiment of the disclosure;

FIG. 2 is a diagram illustrating elements or components that may be present in a computer device or system configured to implement a method, process, function, or operation in accordance with an embodiment of the system and methods disclosed herein; and

FIGS. 3-5 are diagrams illustrating a deployment of the system and methods described herein as a service or application provided through a Software-as-a-Service platform, in accordance with some embodiments.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter will be described with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that this disclosure will satisfy the statutory requirements and convey the scope of the disclosure to those skilled in the art.

Among other forms, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by a suitable processing element or elements (such as a processor, microprocessor, co-processor, CPU, GPU, TPU, QPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user over a network (e.g., the Internet) through a transfer of instructions or an application that executes a set of instructions.

In some embodiments, the systems and methods disclosed herein may provide services to end users through a SaaS or multi-tenant platform. The platform provides access to multiple entities, each with a separate account and associated data storage. Each account may correspond to a user, a set of users, an entity, a set or category of entities, a set or category of users, a set or category of data, an industry, or an organization, for example. Each account may access one or more services (such as applications or functionality), a set of which are instantiated in their account, and which implement one or more of the methods, process, operations, or functions disclosed herein.

In some embodiments, one or more of the operations, functions, processes, or methods disclosed herein may be implemented by a specialized form of hardware, such as a programmable gate array, application specific integrated circuit (ASIC), or the like. Note that an embodiment of the disclosed methods may be implemented in the form of an application, a sub-routine that is part of a larger application, a “plug-in”, an extension to the functionality of a data processing system or platform, or other suitable form. The following detailed description is, therefore, not to be taken in a limiting sense.

Embodiments are directed to systems, apparatuses, and methods for automatically generating text items that may be used on an exam or test. This may be followed by one or more filtering or selecting steps to provide a set of test or exam elements, where each element may be part of an evaluation of a test taker's reading comprehension. In one embodiment, the disclosed system and associated methods provide an end-to-end process to automatically generate reading comprehension texts and accompanying questions, and where a test taker's responses can be automatically scored or evaluated.

In contrast to conventional approaches and instead of depending on input from content experts, the described approach is based on using a Transformer-Based language Model, such as GPT-3, as part of generating the test elements. However, the described approach is not limited to using GPT-3 and could be utilized with other Transformer-based Language Models. Such other models include GPT-2, Pathways Language Model (PaLM), BigScience Large Open-science Open-access Multilingual (BLOOM), or Open Pretrained Transformer (OPT-175B), as non-limiting examples.

In some embodiments, the language model is used to create related texts and other materials to provide reading passages, tasks, correct answers, distractors (i.e., incorrect responses for selected-response items), and other information that may be used to enable automated scoring of a test or exam. In one embodiment, certain materials (e.g., passages and accompanying questions) may be placed on a practice test to collect test taker responses. This form of test data may be used to fine-tune the tasks and/or scoring models implemented by an embodiment of the disclosed system.

In one embodiment, the disclosed approach provides an automated end-to-end process that generates high-level reading comprehension questions (e.g., questions about the main point of a passage or factual questions about the passage) that can be automatically scored. A significant difference between the disclosed approach and conventional state-of-the-art AIG systems is that those systems are limited to text generation with limited question generation capabilities, whereas the disclosed approach enables a full range of test-related tasks, from text generation, to question generation, to enabling automatic scoring of test-taker responses.

For example, FineTune's solutions are presented as “dramatically speeding up assessment item authoring” by generating possible multiple-choice options but does so without a distinction between correct and incorrect responses. As another example, U.S. Pat. No. 11,023,684, assigned to Educational Testing Service, listing Flor (et. al) as inventors and titled “Systems And Methods For Automatic Generation Of Questions From Text” is focused only on question generation from a section of text, without considering text generation or automatic scoring functions. In addition, the system described in the '684 patent generates a relatively large number of possible or candidate questions (approximately one per sentence), leaving the task of sorting through the questions to decide which are most useful to a subject matter expert (SME). Finally, the questions generated by the Flor system are limited to yes-no questions and therefore may not represent test items that are sufficiently effective at evaluating reading comprehension or an understanding of the text.

Further details regarding one or more embodiments of the disclosed system or platform for automatically generating text items and filtering or selecting the generated items to provide a set of test or exam elements are presented in the following sections.

In one embodiment, passages (sections of text for reading by a test-taker) are generated by providing a set of hand-crafted or automatically extracted examples that satisfy a particular format, subject, narrative style, or other characteristic(s). Herein, “extracted” refers to the passages being contained in an existing text corpus that matches a set of desired characteristics, as opposed to being deliberately written by a person to match the desired characteristics. From an existing corpus, texts of varying lengths (sentences, paragraphs, or multi-paragraph segments, as examples) can be extracted using standard text processing methods.

The example passages are manually or automatically labeled with specific attributes (e.g., the name or type of format, or a keyword for the subject matter, as non-limiting examples) as a preliminary step. Examples can then be grouped based on one or more common labels or attributes, with the remainder of the labels used as additional conditioning information when test passages are being generated.

For example, one set of examples may be news articles, each with a different topic. Another set of examples may be a set of short narrative stories, each associated with a title and a set of characters. A third set of examples may be multiple text passages concerning a common topic, each associated with a particular source domain (such as news, textbooks, or blog posts, as examples).

In some embodiments, the remaining attributes (those not used for a grouping of the examples) may be used to provide more direct control over the qualities of the generated text. For example, an attribute can be used to control the topic or domain of the text, the register (as an example, the level of formality, which may be determined by situational characteristics (e.g., relationship among interlocutors/participants, channel mode and medium, language production circumstances, communicative purpose, or topic, as examples), which in turn affects the type of language and choice of words used in that register), or the format (i.e., dialogue, paragraph structure, or an enumerated list, as examples). This provides a flexible approach for generating text with a range of qualities that may be useful for defining test items with different characteristics or goals (e.g., comprehension of different levels of reading texts, organizing information, or identifying supporting and opposing arguments, as examples). The labels describing the properties of the texts can be combined with the texts to serve as part of the input to a transformer-based language model.

In some embodiments, the input(s) to a Transformer-Based Language Model for generating a type of test or evaluation content may comprise three parts:
1. A set of plain-text instructions, describing the generative task (referred to as “Instructions”);
2. A set of examples of the type of content to generate (referred to as “Examples”); and
3. A partially completed example used to conditionally generate the remaining, incomplete parts based on the example(s) (referred to as “Conditioning”).

In one example, the “Instructions” are a human-readable description of the type of content it is desired to generate, in some cases along with other basic information. While not necessary, the Instructions have been shown to improve performance of a model on certain tasks. An example set of Instructions for generating academic texts about a given topic (which are provided as one of the attributes in the “Examples” and “Conditioning”) may be:

“Generate short paragraphs from high school textbooks on the specified topic.”

Note that this Instruction provides the desired format (short paragraphs), level (high-school textbook), and subject matter for the output (the specific topic).

A Transformer-Based Language Model uses the provided Examples to determine the implicit attributes for the generated text. As non-limiting examples, these attributes may include word choice, grammatical structure, and the organization of the content. As mentioned, Examples can have multiple attribute-value pairs, but each Example should have all its attribute-value pairs specified, and the set of attribute-value pairs should be identical for all of the Examples (i.e., for a given task, all Examples should have all attributes in common).

The names and values of the attributes are organized by the order in which the model should generate and/or use the values. For example, to generate a news passage directed to a given topic, a set of news passage Examples might be ordered such that the “Topic” attribute comes first, followed by the “Text” of the Example passage. In this way, the “Topic” attribute can be understood by the model as being connected to the content of the Example's “Text”. In some embodiments, two or more Examples may be joined into a single string of text, connected by a delimiter of a symbol or symbols to indicate a break between the Examples.

The use of examples as an input to a model is sometimes referred to by researchers as a “few-shot” generation scenario, in which the model is provided with only a small number of examples of the desired output format before being operated to generate the output. In other embodiments, no examples may be provided to the model in what is referred to as a “zero-shot” scenario. In a zero-shot scenario, only the Instructions would be provided to the model as an input and all relevant details used to condition the output of the model would be provided in the Instructions.

The Conditioning is a partially (or fully) incomplete Example, which is used to exert more explicit control over the generated content. The attribute-value pairs in the Conditioning should match the order of the attribute-value pairs in the Examples, and attribute-value pairs that are defined in the Conditioning should come in sequential order. In other words, there should be no “gaps” in the attributes defined in the Conditioning when following the order defined in the Examples. Attributes without a corresponding value will be generated by the Transformer-Based Language Model in the same order as the attributes in the Examples. Because the attribute-value pairs of the Conditioning are used to control the generation of subsequent attributes, this affords a higher degree of control over the generated content.

For example, the Conditioning may be a set of attributes that are used to exert more explicit control over the created content, such as the topic and sub-topic(s), or the characters mentioned in a generated passage, as examples. In this case, the Conditioning attributes should be a subset of the attributes present in the Examples and may be used to specify a value or values for those attributes. The order of the attributes in the Conditioning should match the order of the attributes in the Examples.

If an attribute from the Examples is unspecified in the Conditioning, then the Transformer-Based Language Model will generate a value for that attribute as part of its content generation process and then use the generated value as part of the Conditioning for the generated text. In this way, and depending on the needs of the user, the content of the generated passages can be controlled in whole or in part by the user or left to the Transformer-Based Language Model, depending on the specific use case, goal, or task.

In one embodiment, a value (or values) of the attributes in the Conditioning may be determined by a set of heuristics, a rule-based system, or by a machine learning model. For example, a trained classifier may be used to automatically label food reviews with whether a review is positive or negative (and thereby identify the sentiment associated with the review). Those labels may then be used in conjunction with a passage as an Example for a Transformer Model to cause the model to generate a positive review of another, separate product. In this case, an advantage over conventional approaches is that one could generate values for various types of attributes automatically without requiring manual review.

A user could likewise use a machine learning model to verify that the generated text uses or possesses an attribute. For example, this may be done by applying the same classifier model described to a passage generated using a “positive review” label and confirming that the classifier also labels the generated passage as a “positive review”.

For the attributes or characteristics themselves (i.e., the fields or features), one approach is to extend the method described above for generating attribute values. In addition to using a set of heuristics, a rule-based system, or a machine learning model to generate labels for the Examples, one could also use the same technique(s) to generate labels for generated texts. If there is a significant mismatch (or occurrence of mismatches) between the attribute value used to generate the text and a model's predicted label for the text (where the predicted label is expected to indicate the attribute type or class), then this may indicate that the attribute itself is uninformative to the Transformer-based Language Model or is not clearly enough expressed in the Examples. One could use that information to cease using the attribute or to identify Examples which better exemplify the attribute. An advantage of the approach in this case is the ability to identify and validate useful/informative attributes.

As non-limiting examples of possible attributes and corresponding values:
sentiment: (positive, negative);
domain (academic, web text, news, conversations, etc.);
reading level (elementary, middle, high school or college);
topic (science, math, political science, law, etc.); or
Basic observable properties of the text such as # words, # of paragraphs, presence or absence of specific named persons or entities, or presence or absence of keywords.

Identifying informative attributes prior to large-scale generation of text can help practitioners avoid generating large volumes of text based on an attribute that is not used (or not used reliably) by a model. Having a larger number of useful attributes also helps when generating Alternative Passages, as the more attributes that are defined, the more the model will have access to when defining the Conditioning used to generate the Alternative Passages so that they better match a Source Passage.

For example, if the Source Passage were a positive product review for a vacuum and generated based on the Conditioning that the review should be about a “vacuum”, and the generated Alternative Passages were all negative reviews of a vacuum, then answers generated from the Alternative Passages might be too easy to identify.

An Example of an input that might be passed to a Transformer-Based Language Model to generate text in a narrative style is shown below. Examples may be delimited using three equal signs ( [symbol] ). In the following, the Instructions are denoted in bold, the Examples in italics, and the

Conditioning is underlined.

Generate Short Stories Based on the Topic, Characters, and Title.

### Topic: Cars

### Characters: John

### Title: John's New Car

Generated Passage: John was looking to buy a new car but had no idea what kind he wanted. At first, he thought he should buy a basic sedan like his last car, but recently he had been thinking about splurging and buying a fancier sports car. However, sports cars were expensive, and John was worried about how much money he would have to have for a down payment. However, one night, John saw a commercial on T for a local dealership that promised no down payment was necessary. John headed over the next day and ended up leaving with a fancy red sports car.

[symbol]

### Topic: Sports

### Characters: Nora, Travis

### Title: How Nora Learned to Snowboard

Passage: [text of passage]

[symbol]

. . .
Additional examples
. . .

[symbol]

### Topic: Science

### Characters:

Using the above prompt (the Conditioning), the Transformer-based Language Model will generate a list of characters, a title, and a passage all centered around a topic of Science in a style similar to that of the text of the Example passages. The model will output this information in a single response text block, from which the attribute or other values can be extracted. Additionally, a validation process may be performed on the response to ensure that it follows the expected format. An example of an expected response from the Transformer-Based Language Model is shown below:

### Sam, Jane

### Title: Sam and Jane's Big Discovery

Passage: [text of passage]

[symbol]

Note that the first line of the response corresponds to the first attribute in the Conditioning with an unspecified value (“Characters”, in this case).

To determine which of a set of generated passages are suitable (or most suitable) to use for generating test items, the passages may be evaluated and filtered based on one or more of a multitude of criteria, including but not limited to (or required to include) the following:
Minimum/Maximum number of sentences;
Minimum/Maximum number of words;
Minimum/Maximum number of characters;
Presence of duplicated words/phrases/sentences;
Presence of extremely rare words;
Presence of potentially offensive/inappropriate words/phrases/sentences;
Presence of punctuation or grammatical errors;
A measure of the expected difficulty of the passage, as may be estimated by an external machine learning model;
   One embodiment of this type of model is a regression model trained to predict the difficulty of a passage as expressed on the Common European Framework of Reference (CEFR) scale based on features such as word and sentence length, word-level probabilities, and Fisher score features¹; ¹ See Machine Learning-Driven Language Assessment, Burr Settles, Geoffrey T. LaFlair Masato Hagiwara, Transactions of the Association for Computational Linguistics (2020) 8: 247-263.
An estimate of the approximate likelihood of a phrase or sentence in the passage occurring in other situations or from other sources; and/or
An evaluation of how well the passage reflects the targeted domains/registers.

Passages that do not meet one or more of these automatically applied criteria and/or other manually defined criteria are typically excluded from further steps in the processing flow or pipeline. After this filtering of the generated passages, they may undergo a two-step process that includes copy-editing, followed by a fairness and bias review. In the copy-editing stage, passages may be edited or modified by automated processes and/or human editors to account for mechanical or grammatical errors as well as inconsistencies in the logical flow of ideas or cohesive aspects (such as pronouns). Next, passages may additionally be vetted by human reviewers for potential fairness or bias problems. This type of issue can range from inappropriate or potentially offensive content to passages that would unfairly advantage or disadvantage a particular group of test-takers due to systemic differences in knowledge of (or familiarity with) the content.

In some embodiments, the general steps or stages of a process for generating test items are as follows. Given a passage (termed a Source Passage):

1. Define one or more item generation templates, with each template consisting of a set of Instructions and Examples for generating questions and/or answers that can be used as input for a Transformer-Based Language Model;
a. This process and example characteristics of a template are described further herein;

2. Generate a set of passages that are similar to the Source Passage using the above-described passage generation process and defining the Conditioning as a set of attributes and values that are identical to, similar to, or a subset of those of the Source Passage. These new passages (referred to as Alternative Passages) will be similar in style and content to the Source Passage as a result, making them suitable for use in generating incorrect answers for a multiple-choice item (a multiple-choice test question);
Theoretically, an alternative passage could be used as a source passage. For example, someone could compare the source and alternative passages to identify the “best” passage (e.g., by the filtering/labeling methods described), but in some cases, that may not be necessary. The alternative passages could be administered as items on different versions of the same test, as an example, to reduce opportunities for cheating on a test;
With regards to defining the conditioning, if a Source passage was generated using the following conditioning:
   “Topic”: “Science”
   “Title”: “Basics of Quantum Mechanics”,
then the alternative passages would be generated using that same conditioning. Alternative passages could also be generated using a subset of the attributes, such as:
   “Topic”: “Science”
It is also possible to adjust the conditioning used to generate the Alternative Passages in a way that would not substantially change the overall goal of the intended content. How this would be done depends on the attributes used; for example, Alternative Passages could use something similar to the following:
   “Topic”: “Physics”
   “Title”: “Basics of Quantum Mechanics”, or
   “Topic”: “Science”
   “Title”: “Quantum Mechanics”;

3. Generate a set of possible answers to the item using the Instructions and Examples defined in step 1 and the Source Passage as the Conditioning for the Transformer-Based Language Model. These generated answers will be the pool of potential correct answers (termed Correct Candidates);

4. For each of the Alternative Passages, generate a set of possible answers to the item using the Instructions and Examples defined in step 1 and the Alternative Passage as the Conditioning input. These generated answers will be the pool of potential incorrect answers (referred to as Distractor Candidates);

5. Compute one or more metrics for each of the pool of correct candidates. Based on the computed metrics, filter, rank, and select a “correct” answer for the item from the pool of correct candidates. Examples of criteria that may be used as part of the filtering and ranking are listed below, along with a suggested reason for why they could be useful to assist in selecting a correct answer:
a. Minimum/maximum number of words-->ensures candidates are all approximately the same length;
b. The transformer-based model's estimated probability of generating the candidate, conditioned on the Item template and Source Passage-->this identifies potentially unlikely or spuriously generated answers on the part of the model;
c. Similarity to the passage/individual sentences in the passage-->this helps to filter out spurious answers (those with a low similarity value), as well as identify answers that are more likely to match the content of the passage (those with higher similarity);
d. Average similarity to other Correct Candidates-->a model is likely to generate variants of one or more correct answers. Higher average similarity may indicate that the candidate is one of a few variants of a single answer, making it more likely to be correct; and
e. Use of other forms of automated assessments (e.g., by other machine learning models)-->exact purposes vary, but this may provide additional sources of evidence for why a candidate might be a good or bad choice in the context;

6. Compute one or more metrics for each of the pool of distractor candidates. Filter, rank and select an appropriate number of distractors (i.e., incorrect answers) from the pool of distractor candidates. As non-limiting examples, such metrics may include one or more of those mentioned with regards to evaluating the Source Passages or the correct candidates.

Test item generation templates are similar to passage generation templates, with a manually defined set of Instructions and a manually or automatically created set of Examples. For item generation templates, the components of each Example typically consist of a passage, an optional question or requested task (if the text of the task/question depends on the passage), and an optional set of one or more correct answers or responses. To use the template to generate the question and/or correct answer(s), a passage (the Source Passage) is used as the Conditioning information for the transformer model.

For example, a template for a task to generate a plausible next sentence in a story could be formatted as shown below. In the example below, the Instructions are denoted in bold, the Examples in italics, and the Conditioning is underlined.

### Generate a Possible Next Sentence to Continue the Story.

Passage: John was looking to buy a new car but had no idea what kind he wanted. At first, he thought he should buy a basic sedan like his last car, but recently he had been thinking about splurging and buying a fancier sports car. However, sports cars were expensive, and John was worried about how much money he would have to have for a down payment. However, one night, John saw a commercial on TV for a local dealership that promised no down payment was necessary. John headed over the next day and ended up leaving with a fancy red sports car.

### Possible Next Sentences:

1. John was very happy with his new car and couldn't wait to show it off to his coworkers.
2. John was so excited about his new car that he accidentally ended up speeding on the highway and got pulled over by a police officer.
3. Now John likes to spend his weekends washing and waxing his new car to make sure it stays in perfect condition.

[symbol]

Passage: [example passage 2]

### Possible Next Sentences:

1. [example 2.1 candidate]
2. [example 2.2 candidate]
3. [example 2.3 candidate]

[symbol]

. . . Further examples

[symbol]

### Passage: [Source Passage]

### Possible Next Sentences:

1.

Note that in this example, the Conditioning contains the passage, unlike in the examples used to generate passages. Instead, the primary generated content is a possible next sentence in the story. Based on the format of the item template, the Transformer-Based Language Model will respond with multiple such possible sentences.

The item templates may be used to generate multiple choice test items, which will incorporate distractors (i.e., incorrect answers) to construct the test item that a test-taker will see. To do this, the process generates passages that are similar to the Source Passage for the item, which are referred to as Alternative (alternate) Passages. The alternate passages are generated using the previously described passage generation process by using:
1. The same Instructions as were used to generate the Source Passage;
2. The same set of Examples as were used to generate the Source Passage; and
3. All or a subset of the attribute-value pairs from the Source Passage as the Conditioning (excluding the text).

By using the same instructions, examples, and passage attributes that were used to generate the Source Passage, the disclosed process can ensure that the newly generated Alternative Passage(s) will share many of the same characteristics of the Source or original passage. For example, if the Source Passage has three attributes for “Topic”, “Title”, and “Person”, an Alternative Passage can be generated using the same values for those attributes to produce a topically and stylistically similar passage.

Alternative passages can also be generated using a subset of the attribute-value pairs of a Source Passage. A result of this may be an Alternative Passage which is slightly more differentiated from the Source Passage than one which was generated using all of the attributes. A subset of the Source Passage's attribute values could also be modified to produce further differences between the Source Passage and the generated Alternative Passages. The types of modifications to the set of attributes may depend on the type of attributes used to condition the passage. In one non-limiting example, a Source Passage could be generated with the “Topic” attribute of “Physics” and sub-topic of “Gravity”, while its Alternative Passages could be generated using the more general topic “Science” and sub-topic of “Gravity”.

In addition, when generating answers to a multiple-choice question, the alternative passage(s) can be used to generate answers that will likewise be topically and stylistically similar to ones generated using the Source Passage. However, they will differ in terms of exact content, making them appropriate for use as distractors, or incorrect but feasible answers to a question.

The generated Alternative Passages are typically subject to a similar filtering process as the Source or original set of passages, as described in the prior discussion of the passage selection and eligibility criteria. In addition, one can compute the textual similarity between a generated Alternative Passage and the corresponding Source Passage. This may be helpful in filtering out those Alternative Passages that are “too similar” to the Source Passage (i.e., those that might inadvertently produce a correct answer to the Source passage), as well as those that are too different (i.e., those that would produce answers that are significantly and obviously different from the correct one for a Source Passage).

There are multiple methods of computing textual similarity, such as by generating word embeddings (vectors) and comparing two vectors using a defined metric (Euclidean distance or cosine distance, as non-limiting examples). The threshold value used to determine a situation of too great or too little similarity can be tuned based on internally evaluated metrics derived from generated answers and items, as well as by the performance of test takers on generated items and answers. Other approaches to determining textual similarity include evaluating semantic similarity, contextual evaluation, or another suitable approach.

As a further and non-limiting example, textual similarity may be determined by measuring n-gram overlap or measuring the percentage (%) overlap of unique words/word lemmas between two samples. For generating the “word” vectors, suitable approaches include counting occurrences of each word and weighting them (using Term Frequency or Term Frequency-Inverse Document Frequency, known as TF-IDF weight, as an example). One could also or instead use word embeddings produced by a machine learning model, aggregating over the words in a selection of text (by averaging them, or by averaging and normalizing based on statistics from a large collection of texts, as examples).

One could (or instead) also input the text to a neural network model. Two common types of models are transfer-focused sentence encoders and autoencoders. Transfer-focused sentence encoders try to represent a long piece of text in a vector that can be used as an input to other tasks, such as identifying properties of a sentence, as an example. Autoencoders are trained to transform a piece of text into an embedding from which the original sentence can be reproduced.

In one embodiment, the process may generate test items and/or (correct) responses based on a passage using item generation templates. In this embodiment, an item generation template may include (1) the instructions, (2) examples, with each consisting of a passage and one or more correct responses to the task, and (3) the conditioning, consisting of the text of the passage.

For a given passage (the Source Passage), a correct answer to a multiple-choice test item can be generated using an Item Template in conjunction with the Source Passage as the Conditioning, as shown in the prior example (Generate a possible next sentence to continue the story). As also described, a single Item Template can potentially generate multiple correct answers, and a Transformer-based Language Model can be used to generate answers non-deterministically. Therefore, multiple applications of the model may provide a range of different answers; however, the process may also generate answers that are not correct.

To address this concern regarding possible incorrect answers, the Source Passage may be used multiple times to generate a pool of potential correct answers (a set of Correct Candidates). These candidates may then be evaluated using one or more criteria to identify the best possible candidate(s), as described herein.

As mentioned, the Alternative Passages can be used to generate distractors. Each Alternative Passage may be used to generate possible incorrect answers by treating the Alternative Passage as if it were the Source Passage, i.e., pairing it with the Item Template and using a Transformer-based Language Model to generate correct answers for that passage. These answers, when paired with the actual Source Passage, are expected to be incorrect due to the variations in the content of the Alternative Passages compared to the Source Passage. These answers may therefore be used as a set of Distractor Candidates.

As with the Correct Candidates, the transformer model's stochastic generation process could generate answers that are unintentionally correct (or close to being correct) when paired with the Source Passage. As a result, the Distractor Candidates may also be evaluated, similarly to the Correct Candidates, to identify the best possible distractor answers for an item.

To identify “good” (that is suitable or appropriate) candidates out of one or more candidate pools (such as the Correct Candidate or Distractor Candidate pools), embodiments of the disclosed process may define one or more metrics for a given candidate that can be derived from a combination of the Source Passage, the text of the candidate in question, the text of other candidates in the pool, and, when computing metrics for a Distractor Candidate(s), the text and metrics of candidates in the Correct Candidates pool. In general, one or both of correct answers and distractor candidates may be filtered for overly rare words, grammatical errors and/or offensive content, similarly to the filtering that may be applied to passages.

For example, Correct Candidates can be filtered and evaluated based on criteria including but not limited to (or required to include):

1. Minimum or maximum number of words;

2. The Transformer-based Language Model's estimated probability of generating that candidate, conditioned on the Item Template and Source Passage (where a higher probability is indicative of a “better” candidate);

3. Similarity to the passage or to individual sentences in the passage;

4. Average similarity to other Correct candidates; and/or

5. Other forms of automated assessments (e.g., as generated by a trained machine learning (ML) model);
a. an example of such an automated assessment would be a paraphrasing task, where the question asks the test taker to identify which answer best paraphrases a sentence or segment from the text. In this case, a trained ML model that can identify whether two sentences are paraphrases could be used to potentially provide confirmatory evidence that a given “correct answer” is indeed a paraphrase;
b. another example may use a trained model that tries to evaluate the quality of a summary of a piece of text, and which could be used in the ranking equation. This could be used to help rank potential correct candidates based on their estimated “quality”.

Correct Candidates can be ranked based on the values of one or more of the discussed metrics. The ranking method or formula used may vary from item to item but will typically consider the probability of the candidate being generated by the Transformer-based Language Model and its similarity to the passage. The top-ranked candidate may then be selected as the correct answer for an item. Alternatively, for items in which multiple correct answers should be selected from a set of options, the top N candidates may be selected.

Distractor Candidates can similarly be filtered and evaluated based on one or more criteria or metrics, including but not limited to (or required to include):

1. Minimum or maximum number of words;

2. The Transformer-based Language Model's estimated probability of generating that candidate, conditioned on the Item Template and Source Passage (where a lower probability indicates that the candidate is less likely to be correct);

3. Similarity to the passage or to individual sentences in the passage;

4. Average similarity to the other correct candidates;

5. Difference in probability or passage similarity between the distractor and the selected correct candidate(s);

6. Average similarity to other selected distractors; and/or

7. Other forms of automated assessments (e.g., as generated by a trained machine learning (ML) model).

Using these criteria (or similar ones) and derived metrics, Distractors can be filtered and ranked, and the top N selected as incorrect answers for a multiple-choice test item. In some embodiments, the metrics, thresholds, and ranking criteria can be tuned and improved through an analysis of user response data collected on a sample of test items generated using the disclosed process flow (where such a sample may include 25-50 items, with approximately 200 responses to each).

Aside from the reading comprehension example described, the disclosed approach may be used to generate items for an evaluation of a user's “text comprehension”, i.e., items that evaluate a test taker's understanding of a passage or passages (one that may be shown, or that the test taker may have seen before). To that end, the disclosed process may be used to generate factual recall and synthesis-based questions in other domains. For example, a modification of the described process flow or pipeline could have the Source Passages come from an actual textbook that a student has read. The questions could be derived from the text and the rest of the pipeline would be as described, where on the test itself, the student would be expected to recall the facts from memory.

In one embodiment of the disclosed process flow, a test item could be generated that uses two or more Source Passages, where the goal is to ask questions that require a test-taker to compare and contrast the passages. In this example, correct answers could be generated using both passages as the Conditioning, or using Alternative Passages based on one or both the Source Passages. In another embodiment, incorrect answers could be generated using one of the two passages. For example, an item could ask a test taker to identify which sentence best supports the argumentative point of passage A. Correct answers could be generated using passage A or Alternative Passages of passage A as the Conditioning, while incorrect answers could be generated using passage B or Alternative Passages of passage B as the Conditioning.

In another embodiment of the disclosed process flow, a test item could be generated that uses the Source Passage to generate a correct answer and/or comprehension question and does not use distractors. This would simulate a free response reading comprehension question, in which the test taker uses the passage to answer the question in their own words.

In one embodiment, a comprehension question could be generated where the examples consist of a passage, a segment of text from the passage, and a question for which the selected segment of text is the correct answer. Questions could then be generated for a new passage using a Conditioning consisting of the new passage and a segment of text from that passage. These items can be administered in a way that makes them (relatively) easy to grade by asking the test taker to identify (e.g., highlight) the part of the text that answers the question and comparing it with the segment used to generate the question.

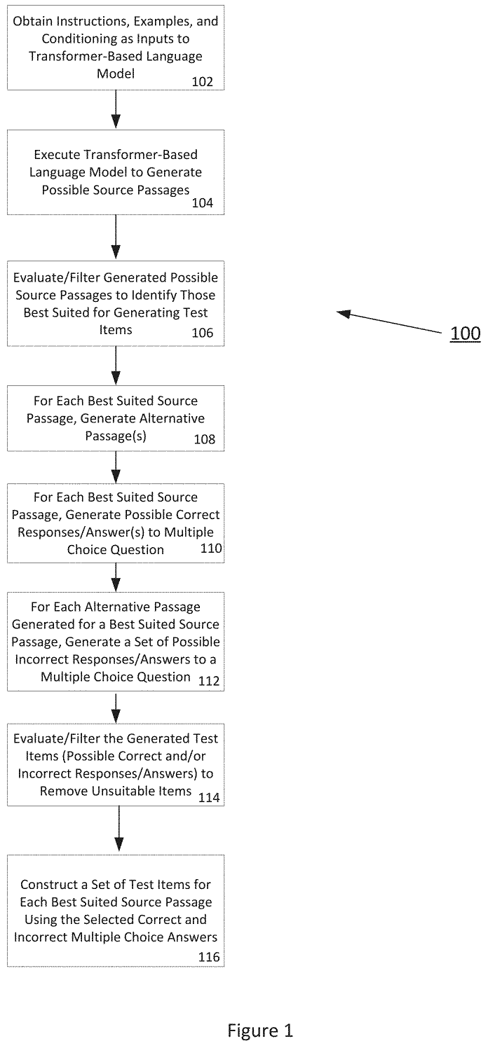

FIG. 1 is a flowchart or flow diagram illustrating a method, process, operation, or set of functions 100 that may be used in implementing an embodiment of the disclosure. As shown in the figure, at step or stage 102 a set of Instructions, Examples, and Conditioning is obtained or constructed for use as inputs to a Transformer-Based Language Model (GPT-3, as a non-limiting example). The Transformer-Based Language Model is executed using the inputs to generate a set of one or more source passages for use in a reading comprehension test with multiple choices as the form of answers, as suggested by step or stage 104 (in this example of a use case).

The set of generated source passages are then evaluated/filtered (as suggested by step or stage 106) to identify those “best suited” for generating test items in the following processing steps. As described, this evaluation or filtering may consider one or more criterion, including but not limited to (or required to include) Minimum or Maximum number of sentences, Minimum or Maximum number of words, Minimum or Maximum number of characters, Duplicated words, phrases, or sentences, the presence of extremely rare words, the presence of potentially offensive or inappropriate words, phrases, or sentences, punctuation or grammatical errors, difficulty, or estimates of the approximate average likelihood of any phrase or sentence in the passage, as non-limiting examples.

Using each of the best suited (or otherwise selected, and in some cases depending on the task a test-taker is being asked to perform) passages as a Source Passage, the process then generates a set of Alternative (alternate) Passages (as suggested by step or stage 108). These are generated using a process similar to that described with reference to step or stage 104, and with the same or similar Conditioning attributes as those used to generate the Source Passage.

Next, for each best suited Source Passage, the process generates a set of possible correct responses or answers to a multiple-choice question (as suggested by step or stage 110) using a Transformer-Based Language Model by providing:
a. A set of Instructions for the model;
b. A set of examples to demonstrate the task;
   i. Each example consists of a text passage and a set of one or more intended correct answers to a type of multiple-choice question using the passage; and
c. A Source Passage for which correct answers will be generated as the Conditioning;

Using the set of Alternative Passages generated for each best suited Source Passage, the process then generates a set of possible incorrect responses or answers to a multiple-choice question (as suggested by step or stage 112) using a Transformer-based Language Model by providing:
a. The same Instructions and Examples used to generate the possible correct responses or answer(s) for the Source Passage; and
b. The Alternative Passage for which responses or answers will be generated is used as the Conditioning.

The process then evaluates/filters the generated test items (the possible correct and/or incorrect responses or answers) to remove categories of subject matter that are not appropriate and/or do not satisfy one or more desired metrics (such as those mentioned herein), as suggested by step or stage 114.

The process then constructs a set of test items for each best suited source passage using the selected response generated for the Source Passage as the correct answer and the selected responses generated for the Alternative Passages as the incorrect answer(s), as suggested by step or stage 116.

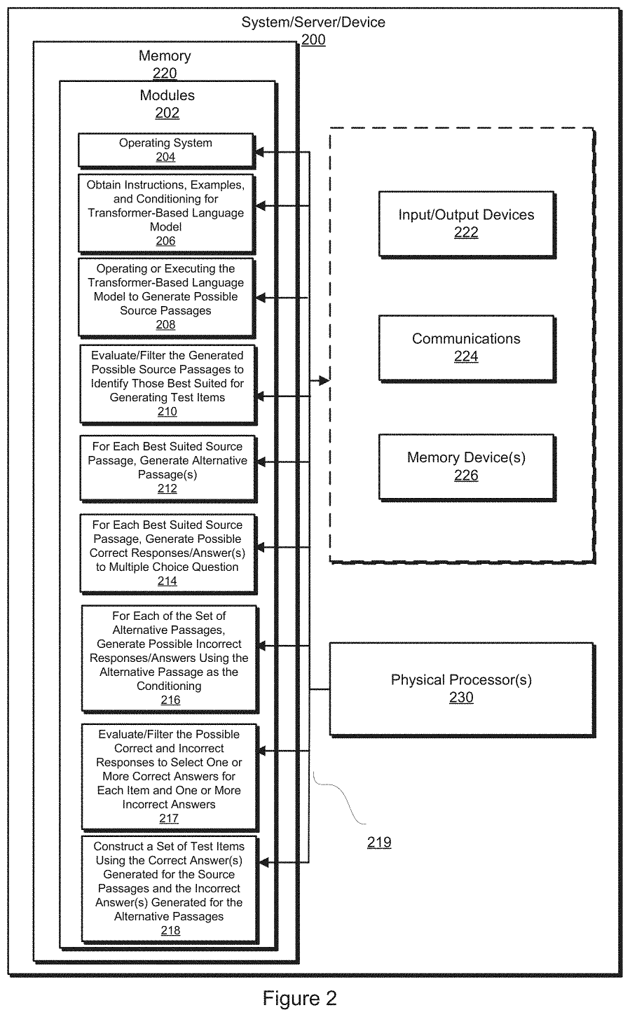

FIG. 2 is a diagram illustrating elements or components that may be present in a computer device, server, or system 200 configured to implement a method, process, function, or operation in accordance with some embodiments. As noted, in some embodiments, the described system and methods may be implemented in the form of an apparatus that includes a processing element or elements and a set of executable instructions stored in a memory. The executable instructions may be part of a software application and arranged into a software architecture.

In general, an embodiment of the disclosure may be implemented using a set of software instructions that are designed to be executed by a suitably programmed processing element (such as a GPU, TPU, CPU, QPU, state machine, microprocessor, processor, co-processor, or controller as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

As shown in FIG. 2, system 200 may represent a server or other form of computing or data processing device. Modules 202 each contain a set of executable instructions, where when the set of instructions is executed by a suitable electronic processor (such as that indicated in the figure by “Physical Processor(s) 230”), system (or server or device) 200 operates to perform a specific process, operation, function, or method.

Modules 202 may contain one or more sets of instructions for performing a method, function, or operation disclosed in the specification and/or with reference to the Figures. These modules may include those illustrated but may also include a greater number or fewer number than those illustrated. Further, the modules and the set of computer-executable instructions that are contained in the modules may be executed (in whole or in part) by the same processor or by more than a single processor.

Modules 202 are stored in a memory 220, which typically includes an Operating System module 204 that contains instructions used (among other functions) to access and control the execution of the instructions contained in other modules. The modules 202 in memory 220 are accessed for purposes of transferring data and executing instructions by use of a “bus” or communications line 219, which also serves to permit processor(s) 230 to communicate with the modules for purposes of accessing and executing a set of instructions. Bus or communications line 219 also permits processor(s) 230 to interact with other elements of system 200, such as input or output devices 222, communications elements 224 for exchanging data and information with devices external to system 200, and additional memory devices 226.

Each application module or sub-module may correspond to a specific function, method, process, or operation that is implemented by the module or sub-module. Each module or sub-module may contain a set of computer-executable instructions that when executed by a programmed processor or processors cause the processor or processors (or a device or devices in which they are contained) to perform the specific function, method, process, or operation. Such function, method, process, or operation may include those used to implement one or more aspects of the disclosed system and methods, such as for:
Obtaining Instructions, Examples, and Conditioning as Inputs for a Transformer-Based Language Model (as suggested by module 206);
Operating or Executing the Transformer-Based Language Model to Generate Possible Source Passages (module 208);
Evaluating or Filtering the Generated Possible Source Passages to Identify Those Best Suited for Generating Test Items (module 210);
Generating a Set of Passages (Alternative or Alternate Passages) Similar to Each Best Suited Source Passage Using Some or All of the Attributes and Values of the Source Passage as the Conditioning (module 212);
Using Each Best Suited Passage as a Source Passage and Conditioning to Generate Possible Correct Response(s) or Answers Based on Item Generation Templates (module 214);
   Although in some embodiments this step or stage may be optional, it is typically used for purposes of generating test items of a particular format;
For Each of the Set of Alternative Passages Similar to the Source Passage, Generating Possible Incorrect Responses or Answers Using the Alternative Passage as the Conditioning (module 216);
Evaluating or Filtering the Possible Correct and Incorrect Responses to Select One or More Correct Answers for Each Item and One or More Incorrect Answers (module 217); and
Constructing a set of test items using the correct answer(s) generated for the Source Passages and the incorrect answer(s) generated for the Alternative Passages (module 218).

As mentioned, each module may contain instructions which when executed in whole or in part by a programmed processor, processors, or co-processors cause an apparatus (such as a server or client device) to perform a specific function or functions. The apparatus may be one or both of a client device or a remote server or platform. Therefore, a module may contain instructions that are executed (in whole or in part) by the client device, the server or platform, or both.

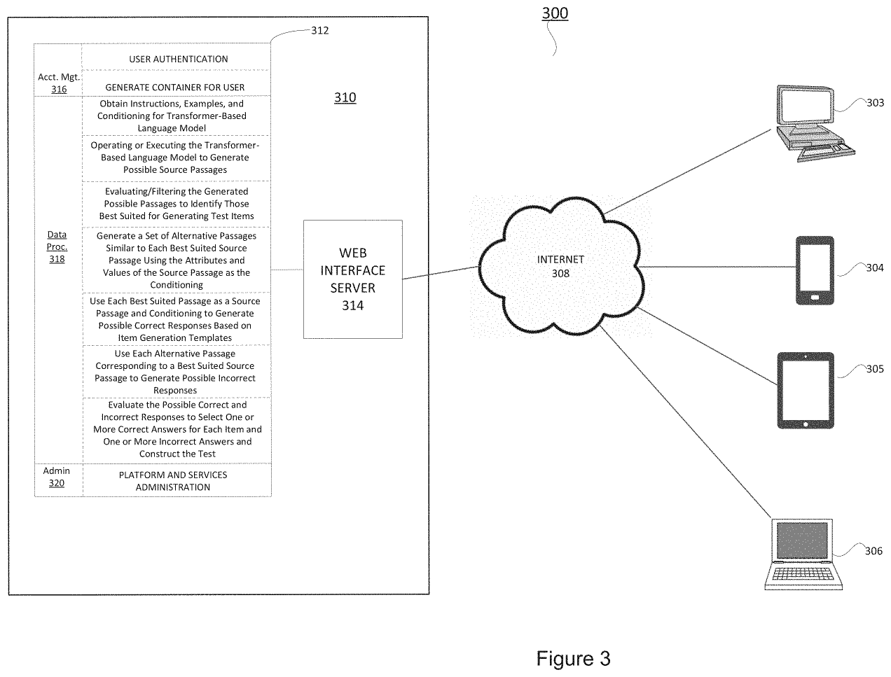

FIGS. 3-5 are diagrams illustrating a deployment of the system and methods described herein for automatically generating and selecting a set of test or examination items as a service or application provided through a multi-tenant or Software-as-a-Service platform, in accordance with some embodiments.

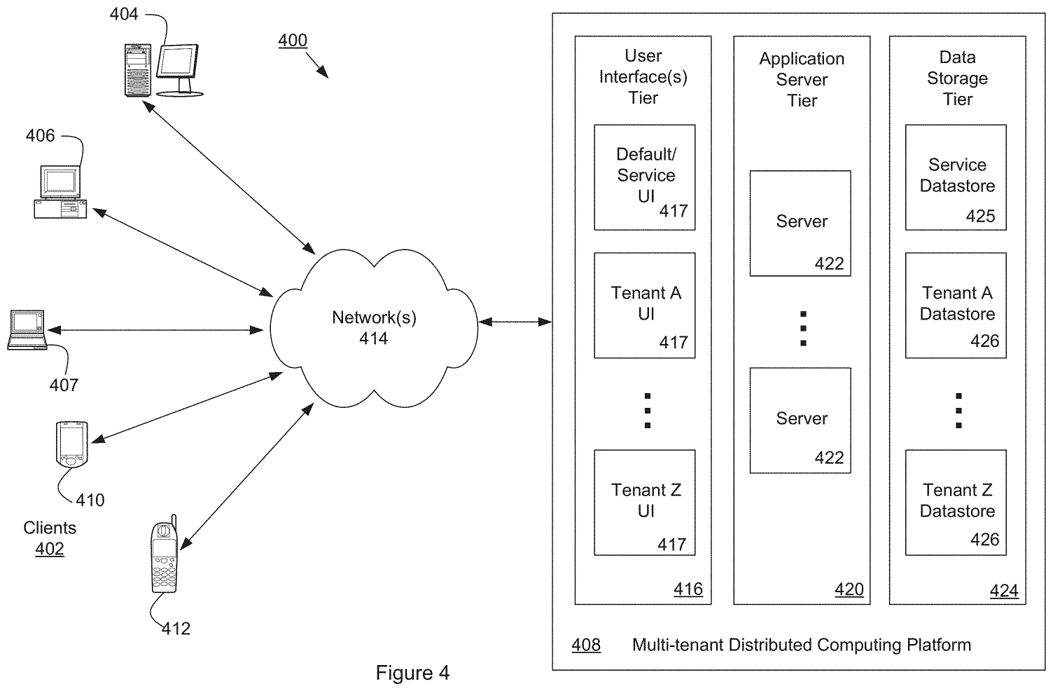

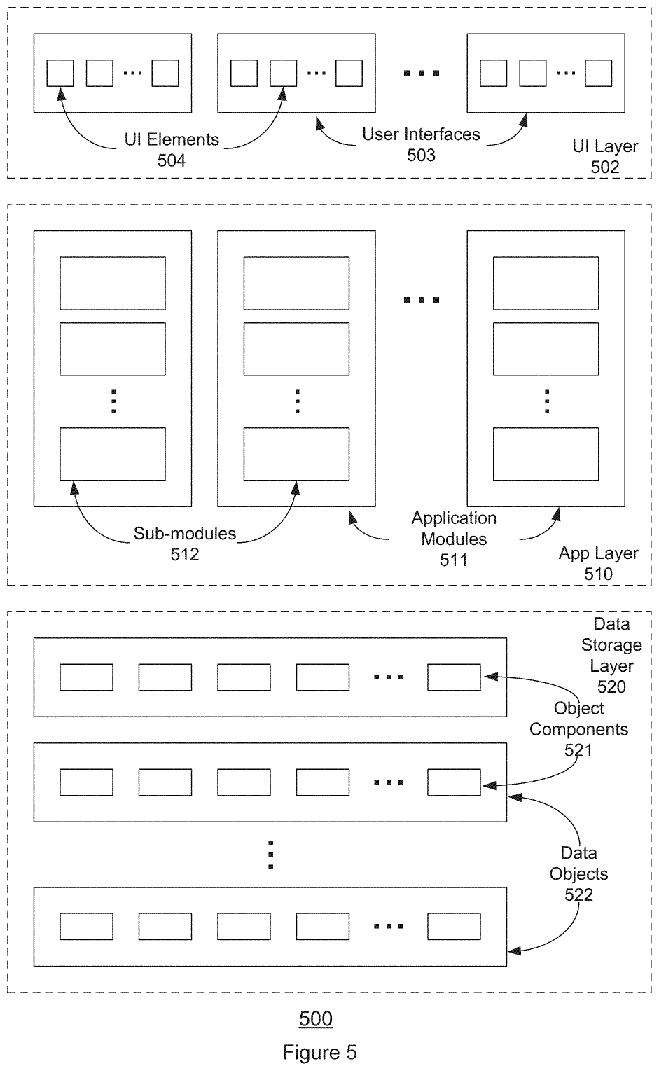

In some embodiments, the functionality and services provided by the system and methods described herein may be made available to multiple users by accessing an account maintained by a server or service platform. Such a server or service platform may be termed a form of Software-as-a-Service (SaaS). FIG. 3 is a diagram illustrating a SaaS system in which an embodiment of the disclosure may be implemented. FIG. 4 is a diagram illustrating elements or components of an example operating environment in which an embodiment of the disclosure may be implemented. FIG. 5 is a diagram illustrating additional details of the elements or components of the multi-tenant distributed computing service platform of FIG. 4, in which an embodiment of the disclosure may be implemented.

In some embodiments, the system or service(s) disclosed or described herein may be implemented as micro-services, processes, workflows, or functions performed in response to a user request. The micro-services, processes, workflows, or functions may be performed by a server, data processing element, platform, or system. In some embodiments, the services may be provided by a service platform located “in the cloud”. In such embodiments, the platform is accessible through APIs and SDKs. The services may be provided as micro-services within the platform for each of multiple users or companies. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide the data processing and test item generation methodology described herein.

Although in some embodiments, a platform or system of the type illustrated in FIGS. 3-5 may be operated by a 3^{rd} party provider to provide a specific set of business-related applications, in other embodiments, the platform may be operated by a provider and a different business may provide the applications or services for users through the platform. For example, some of the functions and services described with reference to FIGS. 3-5 may be provided by a 3^{rd} party with the provider of the functionality maintaining an account on the platform for each company or business using a trained model to provide services to that company's customers.

FIG. 3 is a diagram illustrating a system 300 in which an embodiment of the invention may be implemented or through which an embodiment of the services described herein may be accessed. In accordance with the advantages of an application service provider (ASP) hosted business service system (such as a multi-tenant data processing platform), users of the services described herein may comprise individuals, businesses, stores, organizations, etc. A user may access the services using any suitable client, including but not limited to desktop computers, laptop computers, tablet computers, scanners, smartphones, etc. In general, any client device having access to the Internet may be used to provide a request or text message requesting customer support services and to receive and display an intent tree model. Users interface with the service platform across the Internet 308 or another suitable communications network or combination of networks. Examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. It is to be appreciated that either or both services 312 and the web interface server 314 may be implemented on one or more different hardware systems and components, even though represented as singular units in FIG. 3. Services 312 may include one or more functions or operations for the generation of passages, test items, correct responses, and incorrect responses for use in evaluating a test-taker's reading comprehension, or other capability, as described herein.

In some embodiments, the set of services or applications available to a company or user may include one or more that perform the functions and methods described herein with reference to the enclosed figures. As examples, in some embodiments, the set of applications, functions, operations or services made available through the platform or system 310 may include:
account management services 316, such as
   a process or service to authenticate a person wishing to access the services/applications available through the platform (such as credentials or proof of purchase, verification that the customer has been authorized by a company to use the services, etc.);
   a process or service to generate a container or instantiation of the services, methodology, applications, functions, and operations described, where the instantiation may be customized for a particular user or company; and
   other forms of account management services;
a set 318 of data processing services, applications, or functionality, such as a process or service for one or more of:
   Obtaining Instructions, Examples, and Conditioning as Inputs for a Transformer-Based Language Model;
   Operating or Executing the Transformer-Based Language Model to Generate Possible Source Passages;
   Evaluating/Filtering the Generated Possible Source Passages to Identify Those Best Suited for Generating Test Items;
   Generating a Set of Passages (Alternative or Alternate Passages) Similar to Each Best Suited Source Passage Using Some or All of the Attributes and Values of the Source Passage as the Conditioning;
   Using Each Best Suited Passage as a Source Passage and Conditioning to Generate Possible Correct Response(s) Based on Item Generation Templates;
   For Each of the Set of Alternative Passages Similar to the Source Passage, Generating Possible Incorrect Responses Using the Alternative Passage as the Conditioning;
   Evaluating the Set of Correct and Possible Responses to Select One or More Correct Answers for Each Item and One or More Incorrect Answers; and
   Constructing a set of test items using the answer(s) generated for the Source Passage as the correct answer(s) and the answer(s) generated for the Alternative Passages as the incorrect answer(s); and
administrative services 320, such as
   a process or services to enable the provider of the data processing or test item generation services and/or the platform to administer and configure the processes and services provided to users.

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

FIG. 4 is a diagram illustrating elements or components of an example operating environment 400 in which an embodiment of the invention may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc.

Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As indicated, rather than build and maintain such a platform or system themselves, a business may utilize systems provided by a third party. A third party may implement a business system/platform as described above in the context of a multi-tenant platform, where individual instantiations of a business' data processing workflow (such as the data processing and test item generation disclosed herein) are provided to users, with each company/business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment of the disclosure may be implemented. The software architecture shown in FIG. 5 represents an example of an architecture which may be used to implement an embodiment of the disclosure.

In general, an embodiment may be implemented using a set of software instructions that are designed to be executed by a suitably programmed processing element (such as a CPU, microprocessor, processor, controller, or other form of computing device, as examples). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment of the invention may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing the disclosed data processing and related services to a user of the platform). Such function, method, process, or operation may include those used to implement one or more aspects of the disclosed system and methods, such as for one or more of the processes, services, or functions described with reference to the Figures:
Obtaining Instructions, Examples, and Conditioning as Inputs for a Transformer-Based Language Model;
Operating or Executing the Transformer-Based Language Model to Generate Possible Source Passages;
Evaluating/Filtering the Generated Possible Source Passages to Identify Those Best Suited for Generating Test Items;
Generating a Set of Passages (Alternative or Alternate Passages) Similar to Each Best Suited Source Passage Using Some or All of the Attributes and Values of the Source Passage as the Conditioning;
Using Each Best Suited Passage as a Source Passage and Conditioning to Generate Possible Correct Response(s) Based on Item Generation Templates;
For Each of the Set of Alternative Passages Similar to the Source Passage, Generating Possible Incorrect Responses Using the Alternative Passage as the Conditioning;
Evaluating the Set of Correct and Possible Responses to Select One or More Correct Answers for Each Item and One or More Incorrect Answers; and
Constructing a set of test items using the answer(s) generated for the Source Passage as the correct answer(s) and the answer(s) generated for the Alternative Passages as the incorrect answer(s).

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

In some embodiments, certain of the methods, models, processes, or functions disclosed herein may be embodied in the form of a trained neural network or other form of model derived from a machine learning algorithm. The neural network or model may be implemented by the execution of a set of computer-executable instructions and/or represented as a data structure. The instructions may be stored in (or on) a non-transitory computer-readable medium and executed by a programmed processor or processing element. The set of instructions may be conveyed to a user through a transfer of instructions or an application that executes a set of instructions over a network (e.g., the Internet). The set of instructions or an application may be utilized by an end-user through access to a SaaS platform, self-hosted software, on-premise software, or a service provided through a remote platform.

In general terms, a neural network may be viewed as a system of interconnected artificial “neurons” or nodes that exchange messages between each other. The connections have numeric weights that are “tuned” during a training process, so that a properly trained network will respond correctly when presented with an image, pattern, or set of data. In this characterization, the network consists of multiple layers of feature-detecting “neurons”, where each layer has neurons that respond to different combinations of inputs from the previous layers.

Training of a network is performed using a “labeled” dataset of inputs in an assortment of representative input patterns (or datasets) that are associated with their intended output response. Training uses general-purpose methods to iteratively determine the weights for intermediate and final feature neurons. In terms of a computational model, each neuron calculates the dot product of inputs and weights, adds a bias, and applies a non-linear trigger or activation function (for example, using a sigmoid response function).

Machine learning (ML) is used to analyze data and assist in making decisions in multiple industries. To benefit from using machine learning, a machine learning algorithm is applied to a set of training data and labels to generate a “model” which represents what the application of the algorithm has “learned” from the training data. Each element (or example) in the form of one or more parameters, variables, characteristics, or “features” of the set of training data is associated with a label or annotation that defines how the element should be classified by the trained model. A machine learning model can predict or infer an outcome based on the training data and labels and be used as part of a decision process. When trained, the model will operate on a new element of input data to generate the correct label or classification as an output.

The disclosure includes the following clauses and embodiments:

1. A method of generating an item for a test, comprising:
obtaining an instruction, one or more examples, and a conditioning for a transformer-based language model;
operating the transformer-based language model using the instruction, one or more examples, and conditioning as inputs to generate one or more source passages;
evaluating each of the generated source passages to select a source passage for use in generating the test item;
identifying one or more attributes of the selected source passage;
identifying an associated value for each of the one or more identified attributes of the selected source passage;
generating one or more alternative passages for the selected source passage using one or more of the attributes and associated values of the selected source passage as the conditioning for the transformer-based language model;
generating a multiple-choice question based on the selected source passage;
generating one or more correct responses to the multiple-choice question based on the selected source passage using the selected source passage as a conditioning for the transformer-based language model;
for each of the generated alternative passages for the selected source passage, generating one or more incorrect responses to the multiple-choice question based on the selected source passage by using the alternative passage as the conditioning for the transformer-based language model;
evaluating the generated correct and incorrect responses to select one or more correct answers for the multiple-choice question and one or more incorrect answers; and
constructing a test item using the selected correct and incorrect answers for the multiple-choice question based on the selected source passage.

2. The method of clause 1, wherein evaluating each of the generated source passages comprises using criteria, wherein the criteria include one or more of the minimum or maximum number of words, the minimum or maximum number of characters, the presence or absence of duplicated words, phrases, or sentences, the presence of rare words, the presence of a potentially offensive or inappropriate word, phrase, or sentence, the presence of a punctuation or grammatical error, a measure of the difficulty of the source passage, or an estimate of the likelihood of a phrase or sentence in the source passage.

3. The method of clause 1, wherein the transformer-based language model is a Generative Pre-Trained Transformer.

4. The method of clause 1, wherein generating one or more correct responses to the multiple-choice question based on the selected source passage further comprises using an item generation template, wherein the item generation template comprises one or more of an instruction, one or more examples, with each example consisting of a passage and one or more correct answers, and a conditioning consisting of the selected source passage.

5. The method of clause 1, wherein evaluating the generated correct and incorrect responses to select one or more correct answers for the multiple-choice question and one or more incorrect answers further comprises using criteria, wherein the criteria include one or more of the minimum or maximum number of words, the minimum or maximum number of characters, the presence or absence of duplicated words, phrases, or sentences, the presence of rare words, the presence of an offensive or inappropriate word, phrase, or sentence, or the presence of a punctuation or grammatical error.

6. The method of clause 1, wherein evaluating the generated correct and incorrect responses to select one or more correct answers for the multiple-choice question and one or more incorrect answers further comprises using criteria, wherein the criteria include one or more of similarity to the source text as estimated by vector similarities of the text encoded by a separate language model, similarity to individual sentences within the source text as estimated by vector similarities of the sentences encoded by a separate language model, a degree of N-gram overlap with the source text, a probability of the generated answer by the transformer-based language model, a probability of being correct as estimated by a separately trained model, a length, or a presence of rare words.

7. The method of clause 1, wherein evaluating the generated correct and incorrect responses to select one or more correct answers for the multiple-choice question and one or more incorrect answers further comprises using criteria, wherein the criteria include one or more of similarity to the source text, similarity to the chosen correct answer, similarity to unchosen potential correct answers, similarity to other incorrect answers, a difference in probability of the generated text as measured by the output distribution over tokens of the transformer-based language model between the incorrect answer and the correct answer, a length relative to the chosen correct answer, or a presence of rare words.

8. The method of clause 1, wherein the instruction comprises one or more of a format of a generated passage, a length of the generated passage, a style of the generated passage, or a level of the generated passage.

9. The method of clause 1, wherein the one or more attributes of the selected source passage comprise sentiment, a domain or type of publication in which the source passage would be published, a reading level, a topic, a format, or the presence of a character or keyword.

10. A system for generating an item for a test, comprising:
one or more electronic processors configured to execute a set of computer-executable instructions; and
one or more non-transitory electronic data storage media containing the set of computer-executable instructions, wherein when executed, the instructions cause the one or more electronic processors to
obtain an instruction, one or more examples, and a conditioning for a transformer-based language model;
operate the transformer-based language model using the instruction, one or more examples, and conditioning as inputs to generate one or more source passages;
evaluate each of the generated source passages to select a source passage for use in generating the test item;
identify one or more attributes of the selected source passage;
identify an associated value for each of the one or more identified attributes of the selected source passage;
generate one or more alternative passages for the selected source passage using one or more of the attributes and associated values of the selected source passage as the conditioning for the transformer-based language model;
generate a multiple-choice question based on the selected source passage;
generate one or more correct responses to the multiple-choice question based on the selected source passage using the selected source passage as a conditioning for the transformer-based language model;
for each of the generated alternative passages for the selected source passage, generate one or more incorrect responses to the multiple-choice question based on the selected source passage by using the alternative passage as the conditioning for the transformer-based language model;
evaluate the generated correct and incorrect responses to select one or more correct answers for the multiple-choice question and one or more incorrect answers; and
construct a test item using the selected correct and incorrect answers for the multiple-choice question based on the selected source passage.

11. The system of clause 10, wherein evaluating each of the generated source passages comprises using criteria, wherein the criteria include one or more of the minimum or maximum number of words, the minimum or maximum number of characters, the presence or absence of duplicated words, phrases, or sentences, the presence of rare words, the presence of a potentially offensive or inappropriate word, phrase, or sentence, the presence of a punctuation or grammatical error, a measure of the difficulty of the source passage, or an estimate of the likelihood of a phrase or sentence in the source passage.

12. The system of clause 10, wherein the transformer-based language model is a Generative Pre-Trained Transformer.

13. The system of clause 10, wherein generating one or more correct responses to the multiple-choice question based on the selected source passage further comprises using an item generation template, wherein the item generation template comprises one or more of an instruction, one or more examples, with each example consisting of a passage and one or more correct answers, and a conditioning consisting of the selected source passage.

14. The system of clause 10, wherein evaluating the generated correct and incorrect responses to select one or more correct answers for the multiple-choice question and one or more incorrect answers further comprises using criteria, wherein the criteria include one or more of the minimum or maximum number of words, the minimum or maximum number of characters, the presence or absence of duplicated words, phrases, or sentences, the presence of rare words, the presence of an offensive or inappropriate word, phrase, or sentence, or the presence of a punctuation or grammatical error.

15. The system of clause 10, wherein the instruction comprises one or more of a format of a generated passage, a length of the generated passage, a style of the generated passage, or a level of the generated passage.

16. The system of clause 10, wherein the one or more attributes of the selected source passage comprise sentiment, a domain or type of publication in which the source passage would be published, a reading level, a topic, a format, or the presence of a character or keyword.

17. One or more non-transitory computer-readable media comprising a set of computer-executable instructions that when executed by one or more programmed electronic processors, cause the processors to obtain an instruction, one or more examples, and a conditioning for a transformer-based language model;
operate the transformer-based language model using the instruction, one or more examples, and conditioning as inputs to generate one or more source passages;
evaluate each of the generated source passages to select a source passage for use in generating the test item;
identify one or more attributes of the selected source passage;
identify an associated value for each of the one or more identified attributes of the selected source passage;
generate one or more alternative passages for the selected source passage using one or more of the attributes and associated values of the selected source passage as the conditioning for the transformer-based language model;
generate a multiple-choice question based on the selected source passage;
generate one or more correct responses to the multiple-choice question based on the selected source passage using the selected source passage as a conditioning for the transformer-based language model;
for each of the generated alternative passages for the selected source passage, generate one or more incorrect responses to the multiple-choice question based on the selected source passage by using the alternative passage as the conditioning for the transformer-based language model;
evaluate the generated correct and incorrect responses to select one or more correct answers for the multiple-choice question and one or more incorrect answers; and
construct a test item using the selected correct and incorrect answers for the multiple-choice question based on the selected source passage.

18. The one or more non-transitory computer-readable media of clause 17, wherein evaluating each of the generated source passages comprises using criteria, wherein the criteria include one or more of the minimum or maximum number of words, the minimum or maximum number of characters, the presence or absence of duplicated words, phrases, or sentences, the presence of rare words, the presence of a potentially offensive or inappropriate word, phrase, or sentence, the presence of a punctuation or grammatical error, a measure of the difficulty of the source passage, or an estimate of the likelihood of a phrase or sentence in the source passage.

19. The one or more non-transitory computer-readable media of clause 17, wherein the transformer-based language model is a Generative Pre-Trained Transformer.

20. The one or more non-transitory computer-readable media of clause 17, wherein generating one or more correct responses to the multiple-choice question based on the selected source passage further comprises using an item generation template, wherein the item generation template comprises one or more of an instruction, one or more examples, with each example consisting of a passage and one or more correct answers, and a conditioning consisting of the selected source passage.

The present disclosure can be implemented in the form of control logic using computer software in a modular or integrated manner. Based on the disclosure and teachings provided herein, a person of ordinary skill in the art will know and appreciate other ways and/or methods to implement an embodiment of the disclosure using hardware, software, or a combination of hardware and software.

Any of the software components, processes or functions described in this application may be implemented as software code to be executed by a processor using any suitable computer language such as Python, Java, JavaScript, C++, or Perl using procedural, functional, object-oriented, or other techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, may be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that may direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein may be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

What is claimed is:

1. A method of generating an item for a test, comprising:
obtaining an instruction, one or more examples, and a conditioning for a transformer-based language model;
operating the transformer-based language model using the instruction, one or more examples, and conditioning as inputs to generate one or more source passages;
evaluating each of the generated source passages to select a source passage for use in generating the test item;
identifying one or more attributes of the selected source passage;
identifying an associated value for each of the one or more identified attributes of the selected source passage;
generating one or more alternative passages for the selected source passage using one or more of the attributes and associated values of the selected source passage as the conditioning for the transformer-based language model;
generating a multiple-choice question based on the selected source passage;
generating one or more correct responses to the multiple-choice question based on the selected source passage using the selected source passage as a conditioning for the transformer-based language model;
for each of the generated alternative passages for the selected source passage, generating one or more incorrect responses to the multiple-choice question based on the selected source passage by using the alternative passage as the conditioning for the transformer-based language model;
evaluating the generated correct and incorrect responses to select one or more correct answers for the multiple-choice question and one or more incorrect answers; and
constructing a test item using the selected correct and incorrect answers for the multiple-choice question based on the selected source passage.

2. The method of claim 1, wherein evaluating each of the generated source passages comprises using criteria, wherein the criteria include one or more of the minimum or maximum number of words, the minimum or maximum number of characters, the presence or absence of duplicated words, phrases, or sentences, the presence of rare words, the presence of a potentially offensive or inappropriate word, phrase, or sentence, the presence of a punctuation or grammatical error, a measure of the difficulty of the source passage, or an estimate of the likelihood of a phrase or sentence in the source passage.

3. The method of claim 1, wherein the transformer-based language model is a Generative Pre-Trained Transformer.

4. The method of claim 1, wherein generating one or more correct responses to the multiple-choice question based on the selected source passage further comprises using an item generation template, wherein the item generation template comprises one or more of an instruction, one or more examples, with each example consisting of a passage and one or more correct answers, and a conditioning consisting of the selected source passage.

5. The method of claim 1, wherein evaluating the generated correct and incorrect responses to select one or more correct answers for the multiple-choice question and one or more incorrect answers further comprises using criteria, wherein the criteria include one or more of the minimum or maximum number of words, the minimum or maximum number of characters, the presence or absence of duplicated words, phrases, or sentences, the presence of rare words, the presence of an offensive or inappropriate word, phrase, or sentence, or the presence of a punctuation or grammatical error.

6. The method of claim 1, wherein evaluating the generated correct and incorrect responses to select one or more correct answers for the multiple-choice question and one or more incorrect answers further comprises using criteria, wherein the criteria include one or more of similarity to the source text as estimated by vector similarities of the text encoded by a separate language model, similarity to individual sentences within the source text as estimated by vector similarities of the sentences encoded by a separate language model, a degree of N-gram overlap with the source text, a probability of the generated answer by the transformer-based language model, a probability of being correct as estimated by a separately trained model, a length, or a presence of rare words.

7. The method of claim 1, wherein evaluating the generated correct and incorrect responses to select one or more correct answers for the multiple-choice question and one or more incorrect answers further comprises using criteria, wherein the criteria include one or more of similarity to the source text, similarity to the chosen correct answer, similarity to unchosen potential correct answers, similarity to other incorrect answers, a difference in probability of the generated text as measured by the output distribution over tokens of the transformer-based language model between the incorrect answer and the correct answer, a length relative to the chosen correct answer, or a presence of rare words.

8. The method of claim 1, wherein the instruction comprises one or more of a format of a generated passage, a length of the generated passage, a style of the generated passage, or a level of the generated passage.

9. The method of claim 1, wherein the one or more attributes of the selected source passage comprise sentiment, a domain or type of publication in which the source passage would be published, a reading level, a topic, a format, or the presence of a character or keyword.

10. A system for generating an item for a test, comprising:
one or more electronic processors configured to execute a set of computer-executable instructions; and
one or more non-transitory electronic data storage media containing the set of computer-executable instructions, wherein when executed, the instructions cause the one or more electronic processors to
obtain an instruction, one or more examples, and a conditioning for a transformer-based language model;
operate the transformer-based language model using the instruction, one or more examples, and conditioning as inputs to generate one or more source passages;
evaluate each of the generated source passages to select a source passage for use in generating the test item;
identify one or more attributes of the selected source passage;
identify an associated value for each of the one or more identified attributes of the selected source passage;
generate one or more alternative passages for the selected source passage using one or more of the attributes and associated values of the selected source passage as the conditioning for the transformer-based language model;
generate a multiple-choice question based on the selected source passage;
generate one or more correct responses to the multiple-choice question based on the selected source passage using the selected source passage as a conditioning for the transformer-based language model;
for each of the generated alternative passages for the selected source passage, generate one or more incorrect responses to the multiple-choice question based on the selected source passage by using the alternative passage as the conditioning for the transformer-based language model;
evaluate the generated correct and incorrect responses to select one or more correct answers for the multiple-choice question and one or more incorrect answers; and
construct a test item using the selected correct and incorrect answers for the multiple-choice question based on the selected source passage.

11. The system of claim 10, wherein evaluating each of the generated source passages comprises using criteria, wherein the criteria include one or more of the minimum or maximum number of words, the minimum or maximum number of characters, the presence or absence of duplicated words, phrases, or sentences, the presence of rare words, the presence of a potentially offensive or inappropriate word, phrase, or sentence, the presence of a punctuation or grammatical error, a measure of the difficulty of the source passage, or an estimate of the likelihood of a phrase or sentence in the source passage.

12. The system of claim 10, wherein the transformer-based language model is a Generative Pre-Trained Transformer.

13. The system of claim 10, wherein generating one or more correct responses to the multiple-choice question based on the selected source passage further comprises using an item generation template, wherein the item generation template comprises one or more of an instruction, one or more examples, with each example consisting of a passage and one or more correct answers, and a conditioning consisting of the selected source passage.

14. The system of claim 10, wherein evaluating the generated correct and incorrect responses to select one or more correct answers for the multiple-choice question and one or more incorrect answers further comprises using criteria, wherein the criteria include one or more of the minimum or maximum number of words, the minimum or maximum number of characters, the presence or absence of duplicated words, phrases, or sentences, the presence of rare words, the presence of an offensive or inappropriate word, phrase, or sentence, or the presence of a punctuation or grammatical error.

15. The system of claim 10, wherein the instruction comprises one or more of a format of a generated passage, a length of the generated passage, a style of the generated passage, or a level of the generated passage.

16. The system of claim 10, wherein the one or more attributes of the selected source passage comprise sentiment, a domain or type of publication in which the source passage would be published, a reading level, a topic, a format, or the presence of a character or keyword.

17. One or more non-transitory computer-readable media comprising a set of computer-executable instructions that when executed by one or more programmed electronic processors, cause the processors to
obtain an instruction, one or more examples, and a conditioning for a transformer-based language model;
operate the transformer-based language model using the instruction, one or more examples, and conditioning as inputs to generate one or more source passages;
evaluate each of the generated source passages to select a source passage for use in generating the test item;
identify one or more attributes of the selected source passage;
identify an associated value for each of the one or more identified attributes of the selected source passage;
generate one or more alternative passages for the selected source passage using one or more of the attributes and associated values of the selected source passage as the conditioning for the transformer-based language model;
generate a multiple-choice question based on the selected source passage;
generate one or more correct responses to the multiple-choice question based on the selected source passage using the selected source passage as a conditioning for the transformer-based language model;
for each of the generated alternative passages for the selected source passage, generate one or more incorrect responses to the multiple-choice question based on the selected source passage by using the alternative passage as the conditioning for the transformer-based language model;
evaluate the generated correct and incorrect responses to select one or more correct answers for the multiple-choice question and one or more incorrect answers; and
construct a test item using the selected correct and incorrect answers for the multiple-choice question based on the selected source passage.

18. The one or more non-transitory computer-readable media of claim 17, wherein evaluating each of the generated source passages comprises using criteria, wherein the criteria include one or more of the minimum or maximum number of words, the minimum or maximum number of characters, the presence or absence of duplicated words, phrases, or sentences, the presence of rare words, the presence of a potentially offensive or inappropriate word, phrase, or sentence, the presence of a punctuation or grammatical error, a measure of the difficulty of the source passage, or an estimate of the likelihood of a phrase or sentence in the source passage.

19. The one or more non-transitory computer-readable media of claim 17, wherein the transformer-based language model is a Generative Pre-Trained Transformer.

20. The one or more non-transitory computer-readable media of claim 17, wherein generating one or more correct responses to the multiple-choice question based on the selected source passage further comprises using an item generation template, wherein the item generation template comprises one or more of an instruction, one or more examples, with each example consisting of a passage and one or more correct answers, and a conditioning consisting of the selected source passage.
